(19) United States
(12) Patent Application Publication
(10) Pub. No.: US 2026/0138196 A1
(43) Pub. Date: May 21, 2026

(54) CUTTING TOOL INCLUDING A HOLE SAW ARBOR ASSEMBLY

(71) Applicant: MILWAUKEE ELECTRIC TOOL CORPORATION, Brookfield, WI (US)

(72) Inventors: Timothy M. Whitty, Kenosha, WI (US); Alexander A. Chollet, Milwaukee, WI (US)

(21) Appl. No.: 19/389,359

(22) Filed: Nov. 14, 2025

Related U.S. Application Data
(60) Provisional application No. 63/722,688, filed on Nov. 20, 2024.

(51) Int. Cl. B23B 51/04

(52) U.S. Cl. CPC B23B 51/0473

(57) ABSTRACT

A cutting tool may include a hole saw adapter configured to couple to a hole saw, the adapter including a first portion, a second portion opposite the first portion, and a flange between the first and second portions, the first portion including a threaded outer surface that receives the hole saw, the second portion including a polygonal outer surface. A cutting tool may include an arbor assembly including a coupler body defining a bore that receives the second portion of the adapter, a shank extending from the coupler body and configured to be coupled to a power tool, a sleeve moveable relative to the coupler body, and a retaining member disposed between the sleeve and the coupler body, the retaining member engaging the second portion of the adapter to releasably secure the adapter to the arbor assembly.

### CROSS-REFERENCE TO RELATED APPLICATION

This application claims priority to co-pending U.S. Provisional Patent Application No. 63/722,688, filed November 20, 2024, the entire contents of which are incorporated by reference herein.

### BACKGROUND

The present invention relates to arbor assemblies and, more particularly, to quick-release arbor assemblies for hole saws.

Typically, a hole saw is coupled to a rotating power tool using an arbor assembly. An aperture defined by the hole saw is configured to receive a portion of the arbor assembly. Furthermore, the aperture corresponds to threads on the portion of the arbor assembly such that the hole saw is rotatably coupled to threads of the portion of the arbor assembly. Quick removal of the hole saw from the arbor assembly is typically desired.

### SUMMARY

In some aspects, the techniques described herein relate to a cutting tool including: a hole saw adapter configured to couple to a hole saw, the adapter including a first portion, a second portion opposite the first portion, and a flange between the first and second portions, the first portion including a threaded outer surface that receives the hole saw, the second portion including a polygonal outer surface; and an arbor assembly including a coupler body defining a bore that receives the second portion of the adapter, a shank extending from the coupler body and configured to be coupled to a power tool, a sleeve moveable relative to the coupler body, and a retaining member disposed between the sleeve and the coupler body, the retaining member engaging the second portion of the adapter to releasably secure the adapter to the arbor assembly.

In some aspects, the techniques described herein relate to a cutting tool including: a hole saw; a pilot bit; an arbor assembly including a coupler body defining a longitudinal axis, the coupler body including a central bore that receives the pilot bit and a first aperture extending into the central bore, a shank extending from the coupler body configured to couple to a power tool, and a sleeve supported on the coupler body and including a second aperture, the sleeve moveable between a first position, in which the hole saw is coupled to the arbor assembly, and a second position, in which the hole saw is selectively removable from the arbor assembly; and a retaining member operable to be received through the first and second apertures to secure the pilot bit to the arbor assembly.

In some aspects, the techniques described herein relate to a cutting tool including: a hole saw; a pilot bit; a hole saw adapter coupled to the hole saw, the adapter including, a main body having a first portion, a second portion opposite the first portion, and a flange between the first and second portions, and a collar including pins received by the hole saw, the collar being selectively secured to the main body and axially movable relative to the main body; and an arbor assembly including, a coupler body defining a bore that receives the second portion of the adapter, the coupler body defining a longitudinal axis of the arbor assembly, a shank extending from the coupler body and configured to be coupled to a power tool, a sleeve moveable relative to the coupler body in a direction parallel to the longitudinal axis, and a retaining member disposed between the sleeve and the coupler body, the retaining member engaging the second portion of the adapter to releasably secure the adapter to the arbor assembly.

Other aspects of the invention will become apparent by consideration of the detailed description and accompanying drawings.

### BRIEF DESCRIPTION OF THE DRAWINGS

FIG. 1 is a perspective view of a hole saw and an arbor assembly.

FIG. 2 is an exploded perspective view of the arbor assembly of FIG. 1.

FIG. 3 is a partially exploded cross-sectional view of the arbor assembly of FIG. 1 illustrating assembling the arbor assembly.

FIG. 4 is a cross-sectional view of the arbor assembly of FIG. 1 illustrating disassembling the arbor assembly.

FIG. 5 is a perspective view of an adapter of the arbor assembly.

FIG. 6 is a plan view of an adapter of the arbor assembly according to another embodiment.

FIG. 7 is a plan view of an adapter of the arbor assembly according to another embodiment.

FIG. 8 is an exploded perspective view of an adapter according to another embodiment.

FIG. 9 is an exploded perspective view of an adapter according to another embodiment.

FIG. 10 is an exploded perspective view of an adapter according to another embodiment

FIG. 11 is an exploded perspective view of an arbor assembly according to another embodiment.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

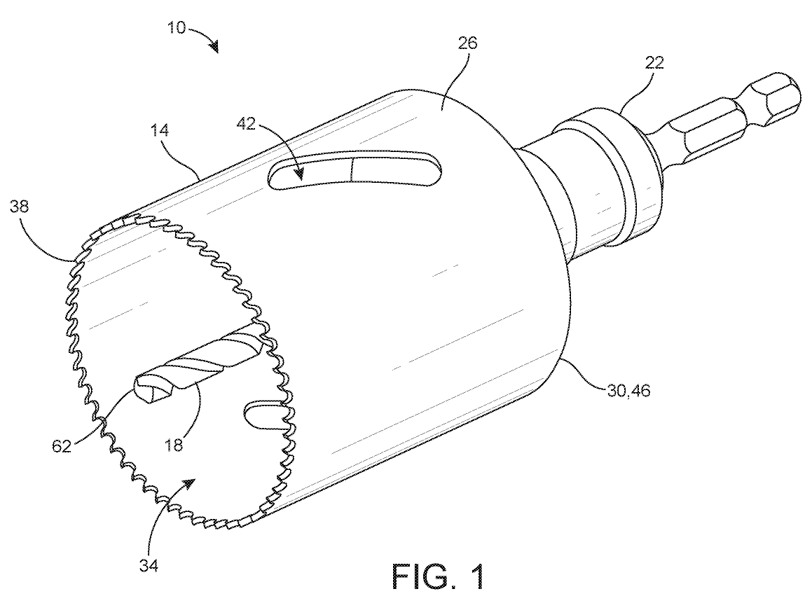

FIG. 1 illustrates a cutting tool 10 including a hole saw 14, a pilot bit 18, and an arbor assembly 22. The arbor assembly 22 allows different types and/or sizes of hole saws and pilot bits to be interchangeably coupled to the arbor assembly 22 without the use of tools. In some embodiments, a tool is required to couple the pilot bit 18 to the arbor. Furthermore, if one part should fail first (e.g., the arbor assembly 22, the pilot bit 18, or the hole saw 14), a user can remove and replace that part instead of needing to throw away the entire cutting tool 10.

The hole saw 14 includes a generally cylindrical body 26 having a first or closed end 30 and a second or open end 34. The closed end 30 is configured to mount to the arbor assembly 22 for connecting the hole saw 14 to a power tool (e.g., a drill). The open end 34 includes a toothform 38 that is configured to cut through a work piece. In the illustrated embodiment, the toothform 38 is defined by a repeating pattern of cutting teeth and gullets. In other embodiments, the toothform 38 may have other configurations. At least one opening 42 is formed in the body 26 of the illustrated hole saw 14 between the closed and open ends 30, 34 to facilitate chip and plug removal from the hole saw 14.

The closed end 30 of the hole saw 14 further includes an end cap 46 coupled to the cylindrical body 26. Although not shown, the end cap 46 defines an opening that receives a portion of the arbor assembly 22 to couple the hole saw 14 to the arbor assembly 22. In some embodiments, the opening includes threads that correspond to threads on a portion of the arbor assembly 22 to couple the hole saw 14 to the arbor assembly 22. In some embodiments, the end cap 46 may also include apertures that receive pins of the arbor assembly 22 as explained in more detail below.

The pilot bit 18 is coupled to the arbor assembly 22 and surrounded by the hole saw 14. The pilot bit 18 includes a cutting portion 62 and a shaft (not shown). The cutting portion 62 extends beyond the open end 34 of the cylindrical body 26. The shaft is generally hex-shaped and corresponds to a portion of the arbor assembly 22 that receives the pilot bit 18. In other embodiments, the shaft may be circular or have a different configuration. In the illustrated embodiment, the pilot bit 18 is a twist drill bit. In other embodiments, the pilot bit 18 may be other types of drill bits, such as a spade bit. The hole saw 14 and the pilot bit 18 are both removable from the arbor assembly 22 separately.

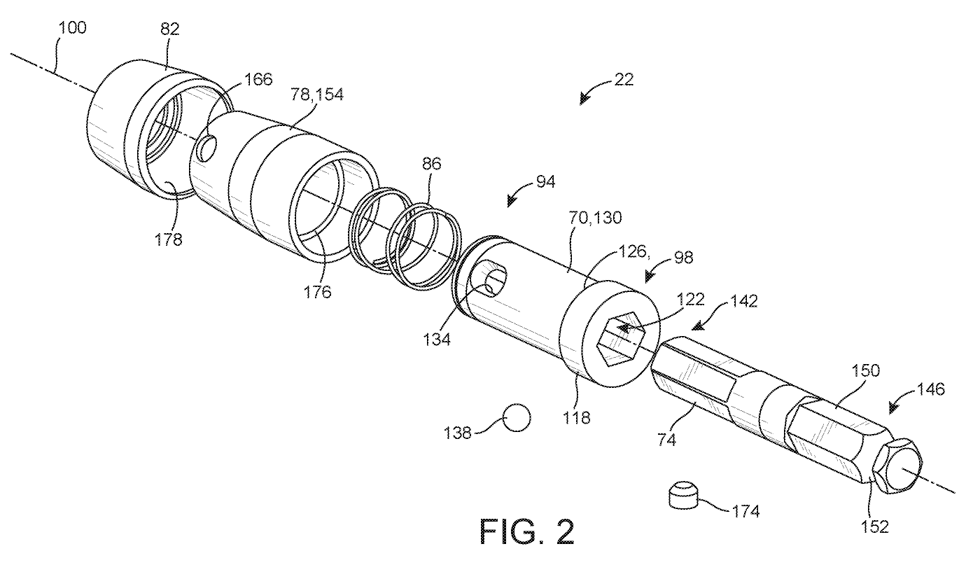

With reference to FIGS. 2-4, the illustrated arbor assembly 22 includes a coupler body 70, a shank 74, a sleeve 78, a collar 82, a biasing member 86 (e.g., a coil spring), and an adapter 90. The coupler body 70 includes a first end 94 and a second end 98 opposite the first end 94. The coupler body 70 defines a longitudinal axis 100 of the arbor assembly 22 that extends centrally through the coupler body 70 between the first and second ends 94, 98. The first end 94 of the coupler body 70 defines a first bore 102 having a first portion 106 operable to receive the shaft of the pilot bit 18 and a second portion 110 operable to receive a portion of the adapter 90. In the illustrated embodiment, the first portion 106 and the second portion 110 include hexagonal cross-sections. As such, the first and second portions 106, 110 are similarly shaped. However, the cross-section of the first portion 106 is smaller than the cross-section of the second portion 110. In other embodiments, the first portion 106 and the second portion 110 may have differently shaped cross-sections. For example, the first portion 106 may include a circular cross-section and the second portion 110 may include a hexagonal cross-section. In still other embodiments, the first portion 106 and/or the second portion 110 may have other circular or non-circular cross-sectional shapes, such as square, D-shaped, oblong, and the like. A fastener aperture 114 extends from an outer surface 130 of the coupler body 70 into the first portion 106 of the first bore 102.

The second end 98 of the coupler body defines a boss 118 and a second bore 122. In some embodiments, the first and second bores 102, 122 may be connected so that a single bore extends between the first and second ends 94, 98 of the coupler body 70. A spring seat 126 is defined between the boss 118 and the outer surface 130 of the coupler body 70. When the arbor assembly 22 is assembled, the biasing member 86 is supported on the coupler body 70 adjacent the spring seat 126. The outer surface 130 of the coupler body 70 is cylindrical. The outer surface 130 also defines a plurality of elongated slots 134 that extend into the first bore 102. The elongated slots 134 support retaining members when the arbor assembly 22 is assembled. In the illustrated embodiment, the retaining members are ball detents 138. In other embodiments, the retaining members may be other types of retaining members, such as retaining pins, springs, clips, and the like. The elongated slots 134 are sized so that the ball detents 138 are allowed to move within the slots 134 in a direction parallel with the longitudinal axis 100 while a portion of the ball detents 138 extend through the elongated slots 134 into the first bore 102. In the illustrated embodiment, the coupler body 70 includes three elongated slots 134 evenly spaced circumferentially about the cylindrical outer surface 130. In other embodiments, the coupler body 70 may include more than three elongated slots 134 or less than three elongated slots 134.

The shank 74 includes a first end 142 and a second end 146 opposite the first end 142. The first end 142 of the shank 74 is hex-shaped and is removably coupled to the coupler body 70. Specifically, the first end 142 of the shank 74 is press fit into the second bore 122 of the coupler body 70 to couple the shank 74 to the coupler body 70. In some embodiments, the first end 142 of the shank 74 may be welded to the coupler body 70 and/or secured to the coupler body 70 with fasteners. In other embodiments, the first end 142 of the shank 74 and the second bore 122 of the coupler body 70 may be shaped differently (e.g., circular or non-circular). In further embodiments, the coupler body 70 and the shank 74 may be formed as a single integral piece. The second end 146 of the shank 74 includes a hex-shaped shaft 150 having an annular groove 152 that is configured to be received in and engaged by a chuck of the power tool. In other embodiments, the second end 146 may include other suitable shafts or coupling mechanisms for connecting to a power tool. In the illustrated embodiment, the shank 74 may be a 3/8” shank or a 7/16” shank. In other embodiments, the shank 74 may be other sizes.

The sleeve 78 is supported on the coupler body 70 and is moveable (e.g., slidable) along the coupler body 70 in a direction parallel to the longitudinal axis 100. In some embodiments, the sleeve 78 may also or alternatively rotate relative to the coupler body 70. The illustrated sleeve 78 is defined by a cylindrical wall 154 extending about the longitudinal axis 100. In some embodiments, the wall 154 defines an outer grip surface with a knurled ring 162 (FIG. 11) that extends circumferentially around the sleeve 78. The knurled ring 162 helps a user grip the arbor assembly 22 during use. A plurality of ball detent apertures 166 extend through the wall 154 and into an interior of the sleeve 78. When the arbor assembly 22 is assembled, the ball detent apertures 166 are positioned adjacent the elongated slots 134 of the coupler body 70. As such, in the illustrated embodiment, the sleeve 78 includes three ball detent apertures 166 that correspond to three elongated slots 134. In other embodiments, the sleeve 78 may include more than or less than three ball detent apertures 166. The sleeve 78 also includes a fastener aperture 170 that extends into the interior. When the arbor assembly 22 is assembled, the fastener aperture 114 of the coupler body 70 and the fastener aperture 170 of the sleeve 78 align. A set screw 174 or other retaining member may be inserted into the first portion 106 of the first bore 102 through the fastener aperture 170 of the sleeve 78 and the fastener aperture 114 of the coupler body 70 to secure the pilot bit 18 to the coupler body 70. The interior side of the wall 154 defines a circumferential rib 176. The biasing member 86 is positioned between the boss 118 of the coupler body 70 and the rib 176 when the arbor assembly 22 is assembled. The biasing member 86 engages (e.g., pushes against) the rib to bias the sleeve 78 away from the boss 118 of the coupler body 70.

The collar 82 is supported on the first end 94 of the coupler body 70. In the illustrated embodiment, the collar 82 is fixed axially relative to the coupler body 70 using a coupling mechanism (e.g., threads, adhesive, fasteners, press fit, welding, etc.). In other embodiments, the collar 82 may be allowed to move axially relative to the coupler body 70. In further embodiments, the collar 82 and the coupler body 70 may be formed as a single integral piece. The collar 82 is generally annular and includes a conically shaped inclined interior surface 178. When the arbor assembly 22 is assembled, the ball detents 138 are positioned between the interior surface 178 and the elongated slots 134. The sleeve 78 biases the ball detents 138 into the inclined interior surface 178 so that a radially inward force is applied to the ball detents 138.

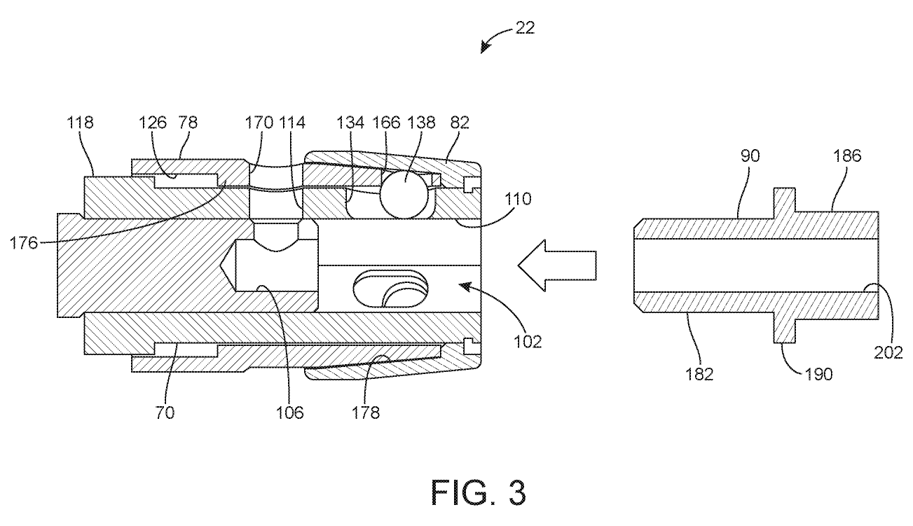

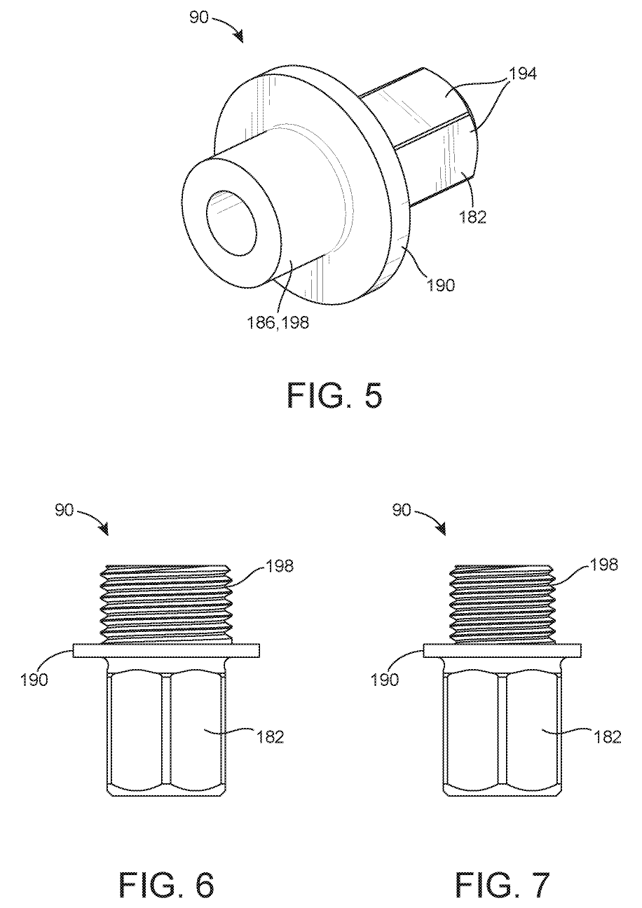

With reference to FIGS. 3 and 5, the adapter 90 includes a first portion 182, a second portion 186, and a flange 190 separating the first portion 182 from the second portion 186. The first portion 182 of the adapter 90 includes a non-circular (e.g., polygonal) outer surface including multiple side faces 194. Specifically, the first portion 182 of the adapter 90 is hex-shaped including six side faces 194. In other embodiments, the first portion 182 may include more than or less than six side faces 194. Each side face 194 of the first portion 182 is smooth and continuous or uninterrupted between the flange 190 and the end of the first portion 182. In other words, there are no grooves, openings, projections, or other features on the side faces 194. In the illustrated embodiment, the first portion 182 of the adapter 90 is a 9/16” shank. In other embodiments, the first portion 182 of the adapter may be a 7/16” shank, a ½” shank, or other sized shanks. The first portion 182 is sized to be received in the second portion 110 of the first bore 102 of the coupler body 70. The second portion 186 of the adapter 90 includes a threaded boss 198 that mates with the threaded opening on the hole saw 14. As shown in FIGS. 6 and 7, the threaded boss 198 may be different sizes to accommodate different sized hole saws. The flange 190 has a larger diameter than both the first portion 182 and the second portion 186. A channel 202 extends centrally through the adapter 90 between the first and second portions 182, 186. The channel 202 is configured to receive and support the pilot bit 18. The adapter 90 is configured to be interchangeable with the arbor assembly 22. In other words, the arbor assembly 22 may include several adapters 90, each adapter 90 including a hole saw that is different from another hole saw (e.g., different sizes). In other embodiments, the adapter 90 is a separate component of the cutting tool 10 from the arbor assembly 22.

To assemble the cutting tool 10, a user can first secure the hole saw 14 to the adapter 90 by coupling the threaded boss 198 to the threaded hole of the hole saw 14. As shown in FIG. 3, to couple the adapter 90 and the hole saw 14 to the arbor assembly 22, a user can align the first portion 182 of the adapter 90 to the second portion 110 of the first bore 102 and axially move the adapter 90 into the first bore 102 until the flange 190 contacts the coupler body 70. As the first portion 182 of the adapter 90 is received in the first bore 102, the ball detents 138 engage the side faces 194. Due to the sleeve 78 biasing the ball detents 138 against the inclined interior surface 178, the ball detents 138 apply a force to the side faces 194 to secure the adapter 90 to the arbor assembly 22. In other words, the ball detents 138 create a wedge between the collar 82 and the adapter 90 to secure the adapter 90 to the arbor assembly 22. With the adapter 90 secured to the arbor assembly 22, a user can selectively couple the pilot bit 18 to the arbor assembly 22. Specifically, a user can slide the pilot bit 18 through the channel 202 of the adapter 90 so that the shaft is received into the first portion 106 of the first bore 102. The set screw 174 can then be inserted through the fastener aperture 170 of the sleeve 78 and the fastener aperture 114 of the coupler body 70 so that the set screw 174 engages a side face of the shaft to secure the pilot bit 18 to the arbor assembly 22. In some embodiments, the pilot bit 18 can be coupled to the arbor assembly 22 before the adapter 90 is coupled to the coupler body 70.

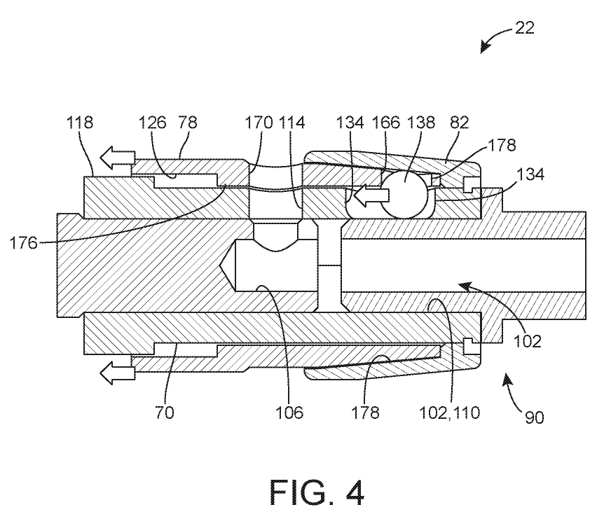

With reference to FIG. 4, to uncouple the adapter 90 from the arbor assembly 22, a user can slide the sleeve 78 axially against the bias of the biasing member 86 towards the boss 118 of the coupler body 70. As the sleeve 78 is slid, the ball detents 138 are unwedged between the collar 82 and the side faces 194 and allowed to move axially within the elongated slots 134. With the radially inward force removed from the adapter 90, a user can slide the adapter 90 axially away from the arbor assembly 22 and out of the first bore 102. As mentioned above, the user can then decide to couple another adapter and hole saw to the arbor assembly 22.

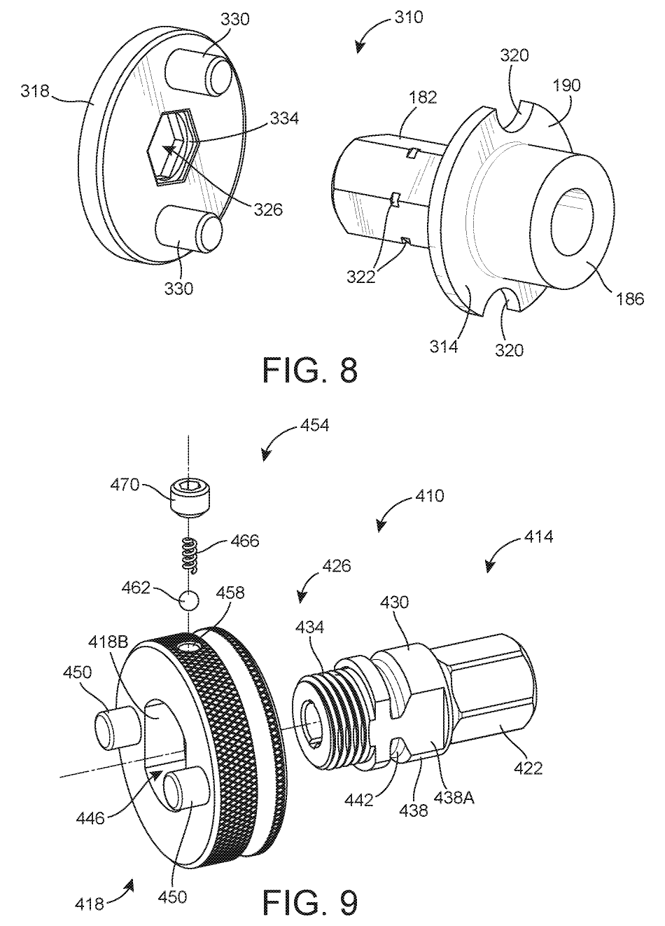

In some embodiments, the hole saw 14 may include apertures adjacent the threaded opening in the end cap 46 that receive locking pins from the arbor assembly 22 that help secure and transfer torque between the hole saw 14 and the arbor assembly 22. As such, FIG. 8

illustrates an adapter 310 for use with a hole saw with apertures. The adapter 310 is similar to the adapter 90 described above with like features being represented with like reference numbers. The adapter 310 includes a main body 314 and a collar 318 selectively moveable relative to the main body 314. The main body 314 includes the first portion 182, the second portion 186, and the flange 190. The flange 190 includes two semi-circular recesses 320 and the first portion 182 includes grooves 322 positioned between adjacent side faces 194. The collar 318 includes a central opening 326 and two pins 330 extending from an upper surface. A retaining ring 334 (e.g., an O-ring) extends around the perimeter of the central opening 326. The retaining ring 334 is received in the grooves 322 to secure the collar 318 to the main body 314. To couple a hole saw to the adapter 310, a user first pulls the collar 318 back relative to the main body 314, removing the retaining ring 334 from the grooves 322. A user can then thread a hole saw onto the second portion 186 of the main body 314. Next, the user can move the collar 318 towards the flange 190 aligning the pins 330 with the semi-circular recesses 320 until the collar 318 is flush with the flange 190.

FIG. 9 illustrates an adapter 410 according to another embodiment. The adapter 410 is similar to the adapter 310 described above with like features being represented with like reference numbers. The adapter 410 includes a main body 414 and a collar 418 selectively secured to the main body 414 and axially moveable relative to the main body 414. The main body 414 includes a first portion 422, a second portion 426, and a flange 430 separating the first portion 422 from the second portion 426. The second portion 426 includes a threaded boss 434 and a contoured outer surface 438 between the flange 430 and the threaded boss 434. The contoured outer surface 438 includes two flat portions 438A that correspond to two flat portions 418B on the collar 418, although only one of each is illustrated. The flat portions 438A, 418B allow for torque from the main body 414 to be evenly transferred to the collar 418. The contoured outer surface 438 also includes a groove 442 on one side of the outer surface 438. The collar 418 includes a central bore 446, two pins 450 extending from an upper surface, and a retention mechanism 454 received in an aperture 458. The retention mechanism 454 includes a ball detent 462, a biasing member 466 (e.g., compression spring), and a plug 470. The biasing member 466 is positioned between the ball detent 462 and the plug 470 and biases the ball detent 462 into the central bore 446 to engage the groove 442. To couple a hole saw to the adapter 410, a user first pulls the collar 418 towards the flange 430 which pushes the ball detent 462 out of engagement with the groove 442. A user can then thread the hole saw onto the second portion 422 of the main body 414. Next, a user can move the collar 418 towards the hole saw while aligning the pins 450 with the apertures on the end cap 46 until the ball detent 462 snaps back into the groove 442.

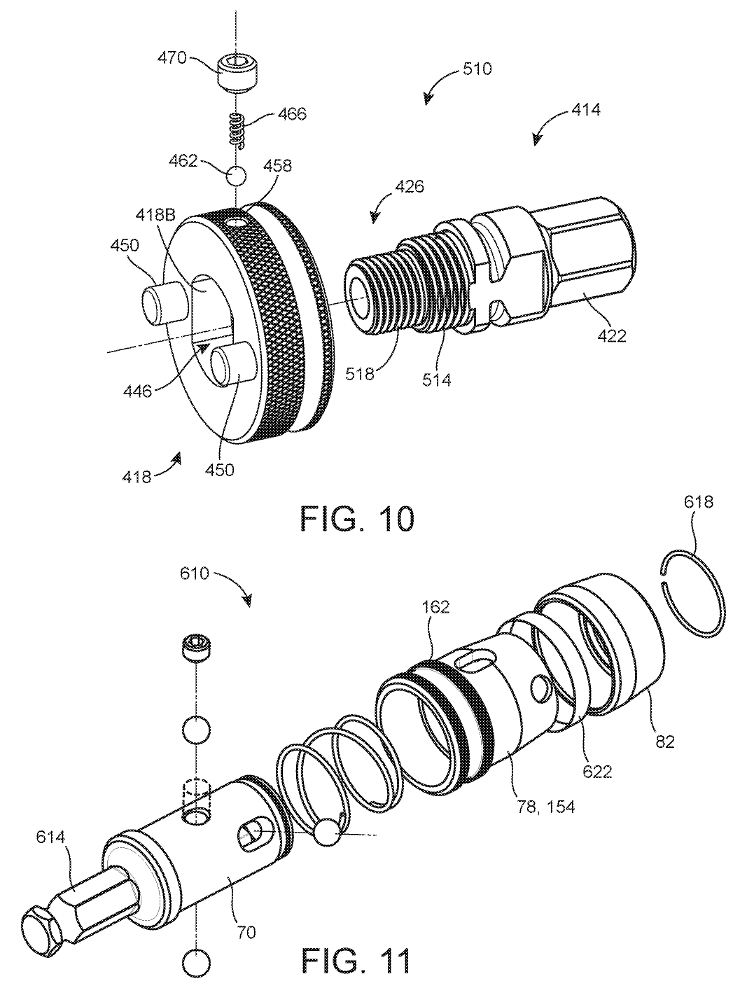

FIG. 10 illustrates an adapter 510 according to another embodiment of the invention. The adapter 510 is similar to the adapter 410 described above with like features being represented with like reference numbers. The second portion 426 of the main body 414 includes a first threaded boss 514 and a second threaded boss 518 extending from the first threaded boss 514. The first threaded boss 514 is configured to receive hole saws with a threaded opening of a first size, and the second threaded boss 518 is configured to receive hole saws with a threaded opening of a second size. For example, the first threaded boss 514 may include “5/8-18” threads, and the second threaded boss 518 may include a “1/2-20” thread. In other embodiments, the first threaded boss 514 and/or the second threaded boss 518 may have different sizes of threads.

FIG. 11 illustrates an arbor assembly 610 according to another embodiment. The arbor assembly 610 is similar to the arbor assembly 22 discussed above, with like features being represented with like reference numbers and only the differences being described in detail below. Specifically, the arbor assembly 610 includes a shank 614 that is integral with the coupler body 70. In addition, the collar 82 is fixed axially relative to the coupler body 70 using a retaining ring 618 in addition to or instead of the coupling mechanism described above. Further, the sleeve 78 includes a band 622 that extends circumferentially about the sleeve 78. The band 622 may indicate to a user the best position to grip the arbor assembly 610. The band 622 may also include markings (e.g., branding) associated with the arbor assembly 610.

Although the invention has been described in detail with reference to certain preferred embodiments, variations and modifications exist within the scope and spirit of one or more independent aspects of the invention as described.

Various features of the disclosure are set forth in the following claims.

What is claimed is:

1. A cutting tool comprising:
a hole saw adapter configured to couple to a hole saw, the adapter including a first portion, a second portion opposite the first portion, and a flange between the first and second portions, the first portion including a threaded outer surface that receives the hole saw, the second portion including a polygonal outer surface; and
an arbor assembly including
a coupler body defining a bore that receives the second portion of the adapter,
a shank extending from the coupler body and configured to be coupled to a power tool,
a sleeve moveable relative to the coupler body, and
a retaining member disposed between the sleeve and the coupler body, the retaining member engaging the second portion of the adapter to releasably secure the adapter to the arbor assembly.

2. The cutting tool of claim 1, wherein the polygonal outer surface includes six sides.

3. The cutting tool of claim 1, wherein the polygonal outer surface is continuous between the flange and an end of the second portion.

4. The cutting tool of claim 1, wherein the coupler body includes an elongated slot that supports the retaining member.

5. The cutting tool of claim 4, wherein the arbor assembly further includes a collar coupled to the coupler body, the collar secures the retaining member in the elongated slot between the sleeve and the coupler body.

6. The cutting tool of claim 5, wherein the collar includes a conically shaped inclined interior surface, and wherein the interior surface biases the retaining member to engage the second portion of the adapter.

7. The cutting tool of claim 1, wherein the sleeve is moveable relative to the coupler body between a first position, in which the adapter is secured to the arbor assembly, and a second position, in which the adapter is removable from the arbor assembly.

8. The cutting tool of claim 7, wherein the arbor assembly further includes a biasing member positioned between the coupler body and the sleeve, the biasing member biasing the sleeve towards first position.

9. The cutting tool of claim 1, wherein the bore includes a first portion and a second portion adjacent the first portion, wherein the first portion is configured to receive a pilot bit, and the second portion receives the second portion of the adapter.

10. The cutting tool of claim 1, wherein the hole saw adapter defines a main body, and the hole saw adapter further includes a collar including pins configured to be received by the hole saw.

11. The cutting tool of claim 10, wherein the collar is selectively secured to the main body and axially movable relative to the main body.

12. The cutting tool of claim 1, wherein the hole saw adapter is a first hole saw adapter configured to receive a hole saw of a first size, and the cutting tool further comprises a second hole saw adapter configured to receive a hole saw of a second size, wherein the first size is different from the second size.

13. The cutting tool of claim 1, wherein the threaded outer surface is a first threaded boss, and the first portion of the hole saw adapter further includes a second threaded boss extending from the first threaded boss.

14. The cutting tool of claim 13, wherein the first threaded boss is configured to receive hole saws with a threaded opening of a first size and the second threaded boss is configured to receive hole saws with a threaded opening of a second size that is different from the first size.

15. A cutting tool comprising:
a hole saw;
a pilot bit;
an arbor assembly including
a coupler body defining a longitudinal axis, the coupler body including a central bore that receives the pilot bit and a first aperture extending into the central bore,
a shank extending from the coupler body configured to couple to a power tool, and
a sleeve supported on the coupler body and including a second aperture, the sleeve moveable between a first position, in which the hole saw is coupled to the arbor assembly, and a second position, in which the hole saw is selectively removable from the arbor assembly; and
a retaining member operable to be received through the first and second apertures to secure the pilot bit to the arbor assembly.

16. The cutting tool of claim 15, wherein the bore includes a first portion that receives the pilot bit and a second portion configured to receive an adapter for the hole saw.

17. The cutting tool of claim 16, wherein the first portion and the second portion are similarly shaped.

18. The cutting tool of claim 17, wherein the first portion is smaller than the second portion.

19. The cutting tool of claim 15, wherein the retaining member is a set screw.

20. A cutting tool comprising:
a hole saw;
a pilot bit;
a hole saw adapter coupled to the hole saw, the adapter including,
a main body having a first portion, a second portion opposite the first portion, and a flange between the first and second portions, and
a collar including pins received by the hole saw, the collar being selectively secured to the main body and axially movable relative to the main body; and
an arbor assembly including,
a coupler body defining a bore that receives the second portion of the adapter, the coupler body defining a longitudinal axis of the arbor assembly,
a shank extending from the coupler body and configured to be coupled to a power tool,
a sleeve moveable relative to the coupler body in a direction parallel to the longitudinal axis, and
a retaining member disposed between the sleeve and the coupler body, the retaining member engaging the second portion of the adapter to releasably secure the adapter to the arbor assembly.
